(19) United States
(12) Patent Application Publication
(10) Pub. No.: US 2007/0070813 A1
(43) Pub. Date: Mar. 29, 2007

(54) Housing for accommodating an audio device for underwater use

(76) Inventor: Jackson Kuo, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/232,940

(22) Filed: Sep. 23, 2005

(51) Int. Cl. H04B 11/00

(52) U.S. Cl. 367/131

(57) ABSTRACT

A housing comprises a rigid container and a lid adapted to fit the rigid container, wherein the rigid container is adapted to accommodate an audio device. A hub with an external recess is formed at an end of the housing. A latch has a buckle and a chuck, wherein the buckle is used for locking the lid with the rigid container, resulting in waterproofing, and the chuck is used for driving the buckle moving and releasing the lid. A control panel is located on the housing for externally controlling the audio device. An audio jack is located in the hub for electric connecting the audio device. An adaptor for sealing and engaging with the hub has a waterproof seal, a plug and a knot on the interior wall of the adaptor.

### BACKGROUND OF THE INVENTION

1. Field of the Invention

The present invention relates to a housing for underwater use, and more particularly to a housing for accommodating an audio device while conducting underwater activities at depths exceeding atmospheric pressure.

2. Description of the Prior Art

Nowadays, scuba diving is very popular as a recreational hobby in the world. The emergence of lightweight and diminutive portable audio players such as compact disc, minidisk, and MP3 players have made feasible the enjoyment of music while engaging in physical exercise, sporting events and other outdoor activities. Such audio devices are not constructed to withstand being submersed and pressurized by an aquatic environment.

FIGS. 1 and 2 are perspective views showing the appearance of a housing of SV-i700 for accommodating an iRiver iFP-700. As shown in FIGS. 1 and 2, the SV-i700 housing 10 mainly includes a container 12, a hub 14, a latch 20 and a control panel 22. The container 12 is adapted to accommodate an audio device 50, such as the iRiver iFP-700, as shown in FIG. 2.

The hub 14 is formed at an end of the SV-i700 housing 10. The latch 20 is attached to and used for locking the container 12, resulting in waterproofing. The control panel 22 is located on the SV-i700 housing 10 for externally controlling the audio device 50. The control panel 22 is used for adjusting the volume of the sound produced by the audio device 50. The control panel 22 is positioned directly on a control knob 52 of the audio device 50. An audio jack 18 is located in the hub 14 for electric connecting the audio device 50. A metal cap 16 is used to cover the hub 14 as shown in FIGS. 1 and 2.

An adaptor 30 comprises a plug 32 in the interior of the adaptor 30 for coupling the audio jack 18 to an earphone (not shown). The adaptor 30 is used for sealing and engaging with the metal cap 16. The adaptor 30 of SV-i700 housing 10 is formed with sort material, such as rubber, resulting in fatigues and deformations after long time use.

Although an object for underwater use of the conventional housing can be achieved, fatigues of the adaptor would easily occur then causing deformations after long time use. Besides, the hub of the conventional housing could need further machining and the metal cap for fitting the adaptor, resulting in a complicated structure and manufacturing.

### SUMMARY OF THE INVENTION

An objective of the present invention is to solve the above-mentioned problems and to provide a housing for accommodating an audio device for underwater use that has an improved hub and adaptor, characterized by a simple structure, easy assembly and manufacturing.

The present invention achieves the above-indicated objective by providing a housing for accommodating an audio device for underwater use. The housing comprises a rigid container and a lid adapted to fit the rigid container, wherein the rigid container is adapted to accommodate an audio device. A hub with an external recess is formed at an end of the housing. A latch has a buckle and a chuck, wherein the buckle is used for locking the lid with the rigid container, resulting in waterproofing, and the chuck is used for driving the buckle moving and releasing the lid. A control panel is located on the housing for externally controlling the audio device. An audio jack is located in the hub for electric connecting the audio device. An adaptor for sealing and engaging with the hub has a waterproof seal, a plug and a knot on the interior wall of the adaptor.

The following detailed description, given by way of example and not intended to limit the invention solely to the embodiments described herein, will best be understood in conjunction with the accompanying drawings.

### BRIEF DESCRIPTION OF THE DRAWINGS

FIG. 1 is partly exploded perspective view of a conventional housing for accommodating an audio device for underwater use;

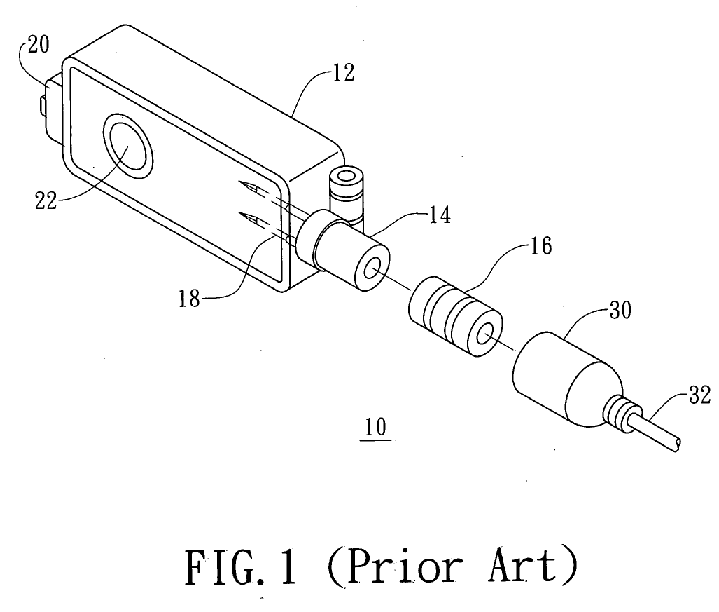

FIG. 2 is a perspective view of the housing of FIG. 1 into which an audio device is accommodated;

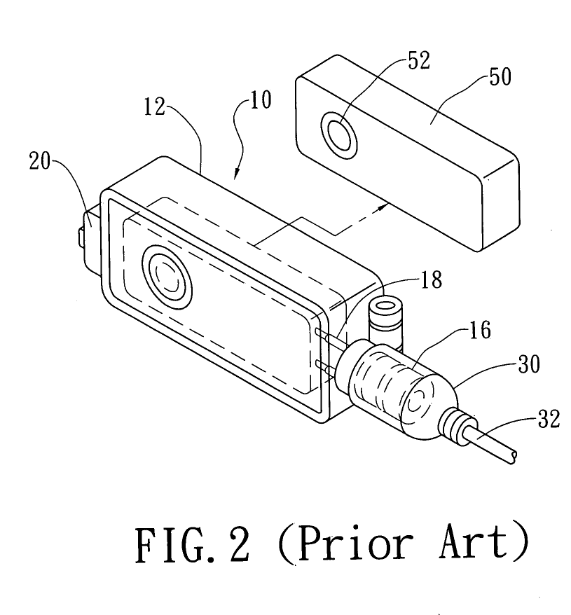

FIG. 3 is a partly exploded perspective view of a housing for accommodating an audio device for underwater use of a preferred embodiment of the present invention;

FIG. 4 is a perspective view of the housing of FIG. 3 into which an audio device is accommodated;

FIG. 5 is a perspective view of a hub of the housing of a preferred embodiment of the present invention; and

FIG. 6 is a perspective view of an adaptor of the housing of a preferred embodiment of the present invention.

### DETAILED DESCRIPTION OF THE PREFERRED EMBODIMENTS

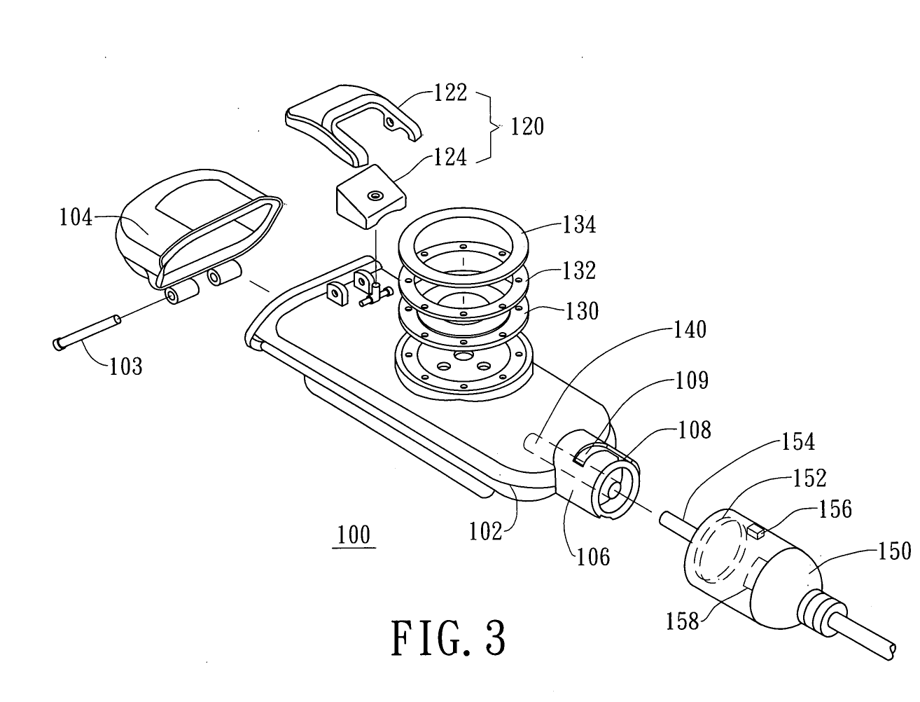

A housing for accommodating an audio device for underwater use according to the preferred embodiment of the present invention will now be described. FIGS. 3-6 show an aspect of the housing for accommodating an audio device for underwater use of a preferred embodiment of the present invention.

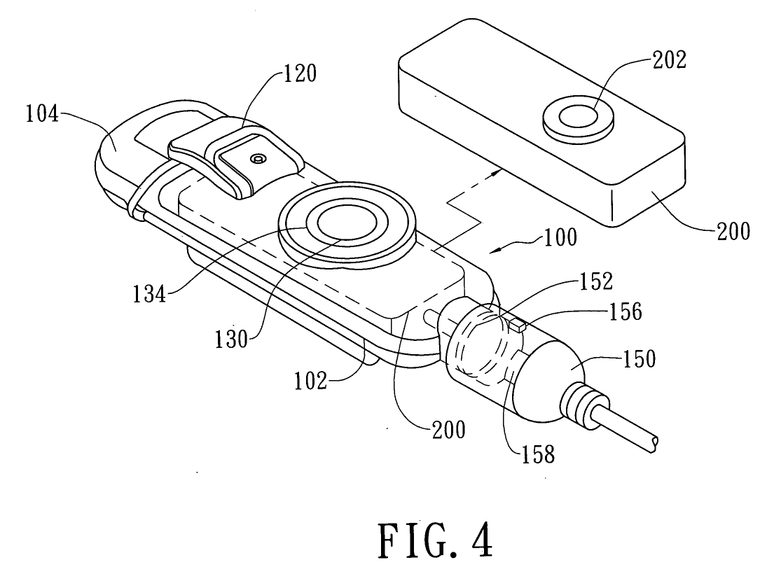

FIG. 3 is a partly exploded perspective view of a housing for accommodating an audio device for underwater use. FIG. 4 is a perspective view of the housing of FIG. 3 into which an audio device is accommodated. The housing 100 includes a rigid container 102 and a lid 104 adapted to fit the rigid container 102, as shown in FIGS. 3 and 4. The housing 100 is capable of withstanding underwater pressures encountered by a SCUBA diver.

The lid 104 of this preferred embodiment is more preferred attached to the rigid container 102 with a pin 103. The rigid container 102 is adapted to accommodate an audio device 200, such as an audio player, MP3 player, CD player, cassette player, DVD player, communication device, telephone, cellular telephone, radio receiver, radio transmitter, computer, laptop computer, palm pilot, personal digital assistant or pager. In this preferred embodiment, the audio device 200 is specifically referred to an iPod shuffle 200, as shown in FIG. 4.

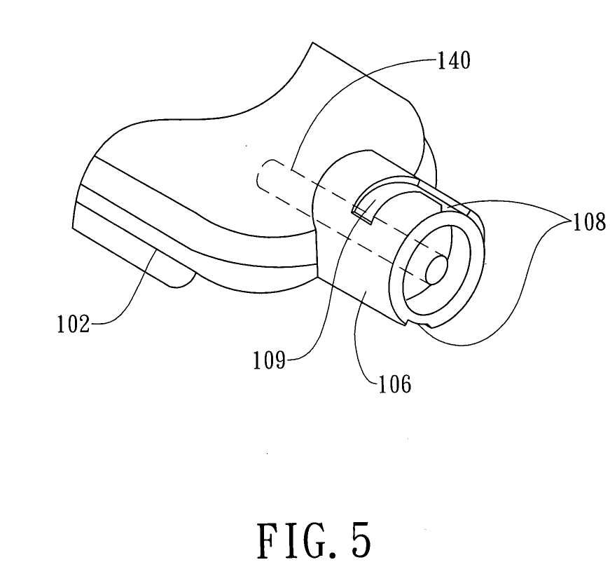

FIG. 5 is a perspective view of a hub of the housing of a preferred embodiment of the present invention. As shown in FIGS. 3 and 5, a hub 106 with an external recess 108 is formed at an end of the housing 100. The external recess 108 can be multiple. A latch 120 can be attached to the rigid container 102 or the lid 104. The latch 120 comprises a buckle 122 and a chuck 124, wherein the buckle 122 is used for locking the lid with the rigid container, resulting in waterproofing, and the chuck 124 is used for driving the buckle 122 moving and releasing the lid 104.

A control panel 130 is located on the housing 100 for externally controlling the audio device 200. A washer 132 and a positioned ring 134 is used for fixing the control panel 130. The control panel 130 is used for adjusting the volume of the sound produced by the audio device 200 and for switching play/stop of the audio device 200. In this preferred embodiment, the control panel 130 can be copied from a control knob 202 of the iPod shuffle 200 and positioned directly on the control knob 202 of the ipod shuffle 200. An audio jack 140 is located in the hub 106 for electric connecting the audio device 200. The rigid container 102 and the hub 106 can be formed integrally with each other.

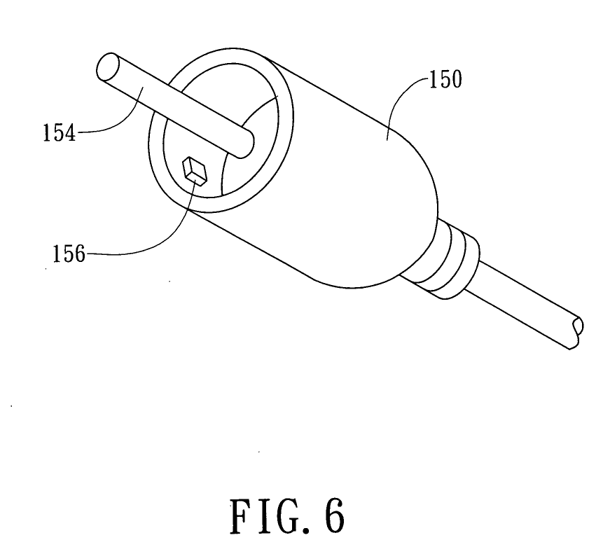

FIG. 6 is a perspective view of an adaptor of the housing of a preferred embodiment of the present invention. As shown in FIGS. 3 and 6, an adaptor 150 comprises a waterproof seal 152, a plug 154 and a knot 156 on the interior wall of the adaptor 150. The adaptor 150 is used for sealing and engaging with the hub 106. The knot 156 is formed at a position corresponded to the external recess 108. The adaptor 150 is sealed and engaged with the hub 106 when the knot 156 is in response to relative rotation of the external recess 108 of the hub 106 and lies in an engaged position 109. The knot 156 can be a plurality depended on the number of the external recess 108.

The plug 154 is in the interior of the adaptor 150 for coupling the audio jack 140 to an earphone (not shown). The waterproof seal 152 can be an o-ring packing. The rigid container 102, the lid 104 and the adaptor 150 are the same material. The material can be a plastic selected from the group consisting of: polyethylene, high density polyethylene, polyvinyl chloride, polypropylene, polycarbonate and acrylonitrile butadiene styrene.

The housing 100 of the present invention further comprises a wireless transmitter 158 located in the adaptor 150, the rigid container 102 or the hub 104 for transmitting signals produced by the audio device 200 to an receiver or a wireless earphone (not shown). In this preferred embodiment, the wireless transmitter 158 is specifically located in the adaptor 150 as shown in FIGS. 3 and 6.

Accordingly, the present invention has following advantages:

1. The hub of the housing of the present invention is formed integrally and needs not further machining or a metal cap for fitting the adaptor. Thus a simple structure and easy assembly of the housing is achieved.

2. The rigid container, the lid and the adaptor are the same material. Thus, a fabrication of the housing can be easily and cost down.

What is claimed is:

1. A housing for accommodating an audio device for underwater use, comprising:
a rigid container and a lid adapted to fit the rigid container, wherein the rigid container is adapted to accommodate an audio device;
a hub with an external recess, formed at an end of the housing;
a latch, attached to the rigid container or the lid for locking the lid with the rigid container, resulting in waterproofing;
a control panel, located on the housing for externally controlling the audio device;
an audio jack, located in the hub for electric connecting the audio device; and
an adaptor, for sealing and engaging with the hub, and having a waterproof seal, a plug and a knot on the interior wall of the adaptor, wherein the plug is in the interior of the adaptor for coupling the audio jack to an earphone.

2. The housing of claim 1, wherein the waterproof seal comprises an o-ring packing.

3. The housing of claim 1, further comprising a wireless transmitter located in the adaptor, the rigid container or the hub for transmitting signals produced by the audio device to an receiver or a wireless earphone.

4. The housing of claim 1, wherein the control panel is used for adjusting the volume of the sound produced by the audio device.

5. The housing of claim 1, wherein the control panel is used for switching play/stop.

6. The housing of claim 1, wherein the adaptor is sealed and engaged with the hub when the knot is in response to relative rotation of the external recess of the hub and lies in an engaged position.

7. The housing of claim 1, wherein the rigid container, the lid and the adaptor are the same material.

8. The housing of claim 7, wherein the material is a plastic selected from the group consisting of: polyethylene, high density polyethylene, polyvinyl chloride, polypropylene, polycarbonate and acrylonitrile butadiene styrene.

9. The housing of claim 1, wherein the rigid container and the hub are formed integrally with each other.

10. The housing of claim 1, wherein the housing is capable of withstanding underwater pressures encountered by a SCUBA diver.

11. The housing of claim 1, wherein the latch comprises a buckle for locking the lid with the rigid container, and a chuck for driving the buckle moving and releasing the lid.

12. The housing of claim 1, wherein the audio device is an iPod shuffle.

13. The housing of claim 12, wherein the control panel is copied from a control knob of the iPod shuffle and positioned directly on the control knob of the iPod shuffle.
